(19) United States
(12) Patent Application Publication
(10) Pub. No.: US 2024/0238743 A1
(43) Pub. Date: Jul. 18, 2024

(54) ELECTROMAGNETIC MIXING

(71) Applicant: ESS TECH, INC., Wilsonville, OR (US)

(72) Inventor: Nicholas Chen, Lake Oswego, OR (US)

(21) Appl. No.: 18/409,674

(22) Filed: Jan. 10, 2024

Related U.S. Application Data
(60) Provisional application No. 63/480,420, filed on Jan. 18, 2023.

(51) Int. Cl. B01F 33/453

(52) U.S. Cl. CPC B01F 33/453; B01F 2101/59

(57) ABSTRACT

Systems and methods are provided for an external electromagnetic mixing system. The external electromagnetic mixing system includes a plurality of electromagnetics spaced externally around a production tank which contains a liquid and a ferromagnetic and/or ferrimagnetic solid. The plurality of electromagnets are configured to move the ferromagnetic and/or ferrimagnetic solid within the liquid.

### CROSS-REFERENCE TO RELATED APPLICATIONS

The present application claims priority to U.S. Provisional Application No. 63/480,420 entitled “ELECTROMAGNETIC MIXING” filed Jan. 18, 2023. The entire contents of the above identified application are hereby incorporated by reference for all purposes.

### FIELD

The present description relates generally to systems and method for mixing ferromagnetic and/or ferrimagnetic solids.

### BACKGROUND AND SUMMARY

Redox flow batteries are suitable for grid scale storage applications due to their capability for scaling power and capacity independently, as well as for charging and discharging over thousands of cycles with reduced performance losses in comparison to conventional battery technologies. Iron hybrid redox flow batteries are particularly attractive due to the incorporation of low cost materials in the cell stack. The iron redox flow battery (IFB) relies on iron, salt, and water for electrolyte. As one example, the iron source may be ferrous chloride (FeCl₂). Preparation of a ferrous chloride solution for an IFB may include reacting pieces of iron metal with concentrated hydrochloric acid. Reacting may include mixing metallic iron pieces with concentrated hydrochloric acid placed inside a production tank. Mixing may be accomplished by pumping of the solution from the preparation tank, through an external loop, and back to the preparation tank. Additionally or alternatively, mixing may be performed manually. The reaction may be heated during preparation to increase a rate at which the iron metal reacts (e.g., dissolves into the hydrochloric acid). Heating may be accomplished by immersion heaters placed within the preparation tank or external heaters positioned around an external wall of the preparation tank.

However, inventors have recognized issues with the above mentioned systems for heating and mixing the electrolyte. The concentrated hydrochloric acid is corrosive, resulting in rapid degradation of components exposed to the solution for prolonged periods of time. For this reason, immersion heaters submerged in the hydrochloric acid and pumps and fittings used to circulate the hydrochloric acid through the external loop may demand frequent replacement. Additionally, the solution may emit fumes such as hydrogen gas and hydrogen sulfide gas. The hydrogen sulfide gas emitted due to a reaction between the concentrated hydrochloric acid and sulfur contaminants may be harmful to a person tasked with mixing the solution manually. Further, because of the corrosive nature of the hydrochloric acid, the preparation tank may be formed of plastic or high alloy stainless steel. Both plastic and stainless steel have low thermal conductivities, resulting in inefficient heating of the solution from heaters positioned around the external wall of the preparation tank.

In one example, the issues described above may be at least partially addressed by an external electromagnetic mixing system, comprising: a plurality of electromagnets spaced externally around a production tank, wherein the production tank contains a liquid and a ferromagnetic and/or ferrimagnetic solid, and wherein the plurality of electromagnets are configured to move the ferromagnetic and/or ferrimagnetic solid within the liquid. In this way, the reaction may be effectively mixed and heated by components which do not directly contact the hydrochloric acid. A useful lifetime of the components may thereby be increased. Additionally, exposure of persons to the fumes emitted by the reaction may be limited. Further, the external electromagnetic mixing system may be readily adapted to different production tanks or moved between a plurality of production tanks.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including electrolyte which may be at least partially prepared by electromagnetic mixing.

FIG. 2A shows an illustration of a side view of an external electromagnetic mixing system and a production tank.

FIG. 2B shows an illustration of a top view of the external electromagnetic mixing system and the production tank.

FIG. 3A shows an illustration of an alternate embodiment of an external electromagnetic mixing system.

FIG. 3B shows an illustration of a cross-sectional view of the alternate embodiment of the external electromagnetic mixing system and a production tank.

FIG. 4 shows a flowchart of an example of a method for reacting hydrochloric acid and metallic iron pieces using an external electromagnetic mixing system.

### DETAILED DESCRIPTION

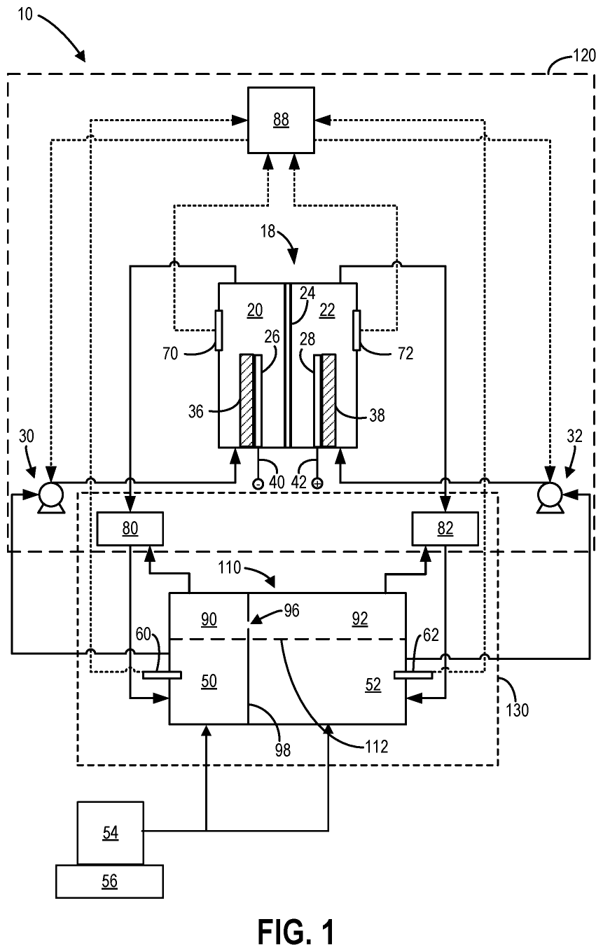

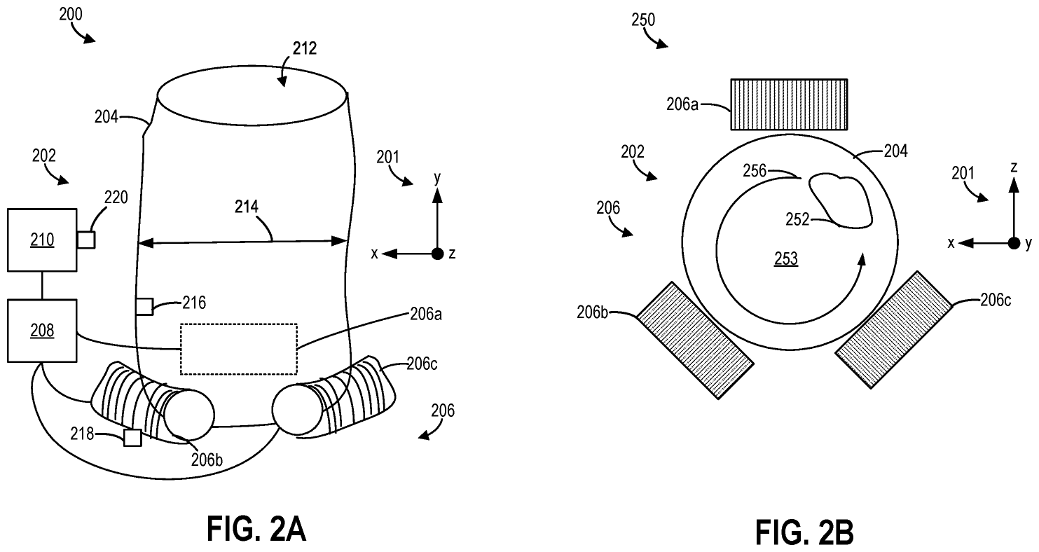

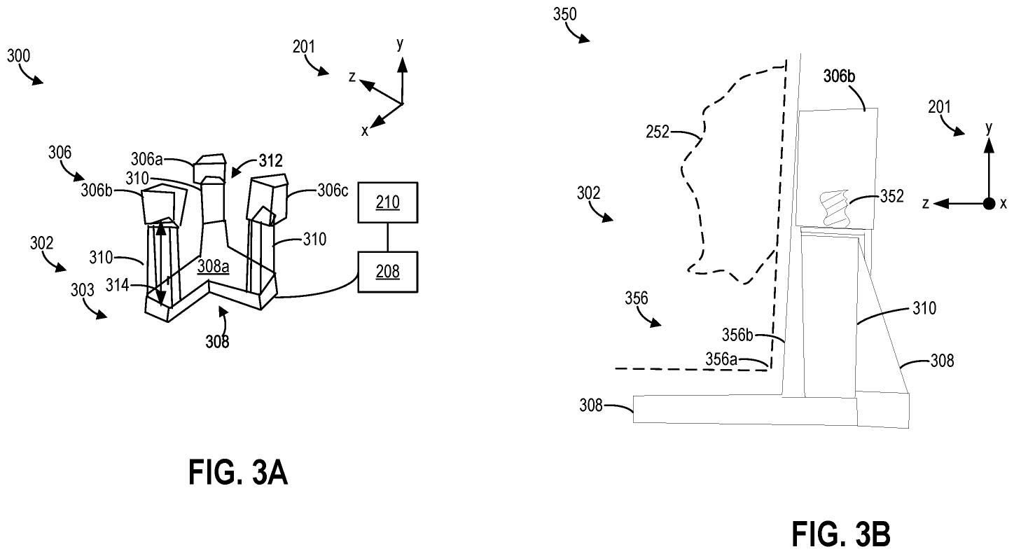

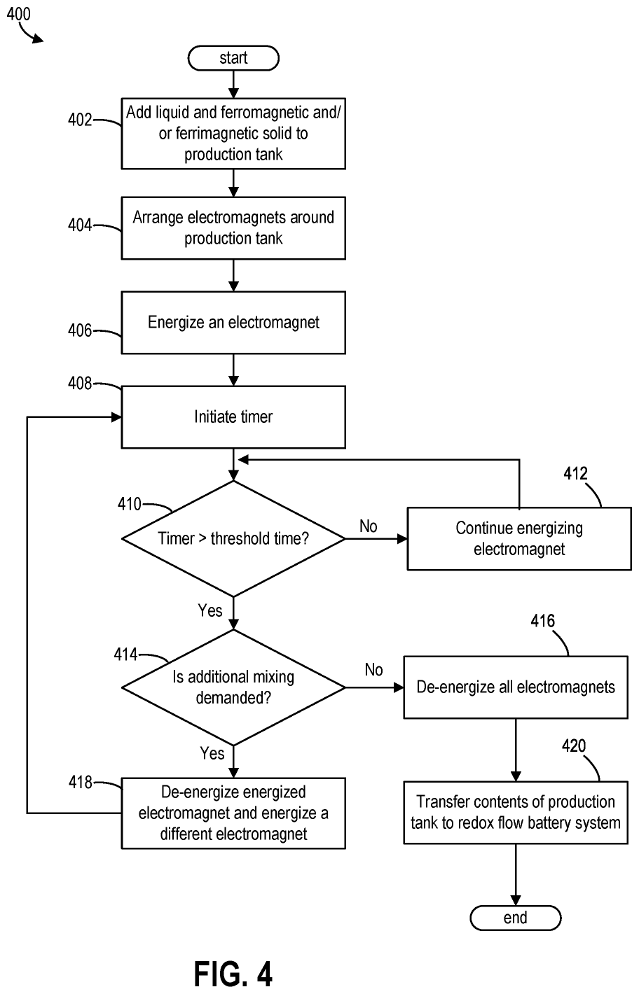

The following description relates to systems and methods for mixing a ferromagnetic and/or ferrimagnetic solid with a liquid. In one example, as described further below, the ferromagnetic and/or ferrimagnetic solid may be pieces of metallic iron and the solvent may be hydrochloric acid. Such a mixture may react when mixed to produce ferrous chloride. The ferrous chloride may be included in an electrolyte for a redox flow battery system, such as the redox flow battery system shown in FIG. 1. Mixing of the ferromagnetic and/or ferrimagnetic solid may be done using an external electromagnetic mixing apparatus positioned a round a production tank as shown in FIG. 2A-2B. An alternate embodiment of the external electromagnetic mixing system is shown in FIGS. 3A-3B. The embodiment shown in FIGS. 2A-2B may be used for a large production tank while the embodiment shown in FIGS. 3A-3B may be used for a small production tank. An example of a method for mixing a ferromagnetic/ferrimagnetic material with a solvent using either embodiment of the external electromagnetic mixing system is shown in FIG. 4.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

$$\begin{matrix}{Fe}^{2 +} + 2 {e}^{-} ↔ {Fe}^{0} & - 0.44 V & ( negative electrode )\end{matrix} \qquad ( 1 )$$

$$\begin{matrix}2 {Fe}^{2 +} ↔ 2 {Fe}^{3 +} + 2 {e}^{-} & + 0.77 V & ( positive electrode )\end{matrix} \qquad ( 2 )$$

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fc(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

In some examples, the ferrous chloride species present in the negative and/or positive electrolyte may be prepared by dissolving (e.g., reacting) metallic iron in concentrated hydrochloric acid within a production tank 54, positioned external to electrolyte subsystem 130. In some embodiments, production tank 54 may be positioned external to redox flow battery system 10. In some examples, stirring and heating to increase a rate of the dissolving process may be performed by an external electromagnetic mixing system 56 positioned around an external surface of production tank 54 as described below with respect to FIGS. 2A-4. The ferrous chloride solution prepared in production tank 54 by mixing using external electromagnetic mixing system 56 may be transferred to redox flow battery system 10. As one example the ferrous chloride solution may be added to negative electrolyte chamber 50 and/or positive electrolyte chamber 52. Further, the majority of the IFB electrolyte may be ferrous chloride in the presence of hydrochloric acid. Hydrochloric acid may be present to maintain a low enough pH to prevent the precipitation of iron hydroxides.

The IFB system described above in FIG. 1 uses electrolyte prepared with ferrous chloride. While the IFB electrolyte may be considered to be non-toxic and environmentally friendly, preparation of the ferrous chloride used in the electrolyte may present challenges. Preparation of ferrous chloride may include forming a ferrous chloride solution by dissolving pieces of metallic iron in concentrated hydrochloric acid. Stirring and heating such a mixture to increase the rate of dissolution may demand prolonged exposure of heating and mixing equipment (e.g., immersion heaters and pumps) to the corrosive ferrous chloride solution thereby causing degradation of the heating and mixing equipment. Previous attempts at stirring and mixing without contacting mechanical components may be ineffective, create hazards for technicians, or may demand costly specialized production tanks. For example, heaters placed external to a preparation tank may be inefficient due to the low thermal conductivity of the corrosion resistant material used to form the preparation tank. Additionally, use of manual labor to stir the ferrous chloride solution may be hazardous to the technician due to noxious fumes given off by high concentration hydrochloric acid and as a result of the oxidation reaction occurring during dissolution. As described below, an external electromagnetic mixing system may be used to overcome the challenges presented by preparation of the strongly acidic ferrous chloride solution. The external electromagnetic mixing system may incite motion of the metallic iron by using externally placed electromagnets to take advantage of the ferromagnetic nature of metallic iron. In this way, components of the external electromagnetic mixing system may increase the rate at which metallic iron dissolves in the hydrochloric acid without directly contacting the hydrochloric acid. Additionally, interaction between the magnetic field generated by the external electromagnetic mixing system and the metallic iron pieces may result in heating of the metallic iron pieces, thereby further increasing the dissolution rate.

Referring now to FIG. 2A-2B, illustrations of an embodiment of an external electromagnetic mixing system 202 is shown. FIG. 2A shows a front view 200 of external electromagnetic mixing system 202 and FIG. 2B shows a top view 250 of external electromagnetic mixing system 202. A coordinate system 201 including an x-axis, y-axis, and z-axis is shown in FIGS. 2A-2B. The same coordinate system may be used for reference in illustrations of an alternate embodiment of the external electromagnetic mixing system shown in FIGS. 3A-3B. The y-axis of coordinate system 201 may be parallel with a gravitational axis.

External electromagnetic mixing system 202 may include a first electromagnet 206a, second electromagnet 206b, and third electromagnet 206c (collectively referred to as electromagnets 206). In one embodiment, electromagnets 206 may include 3 electromagnets. In alternate embodiments, electromagnets 206 may include a plurality of electromagnets (e.g., at least 2 electromagnets). Electromagnets 206 may be positioned in direct face sharing contact with an external surface of a production tank 204. In one example, electromagnets 206 may be spaced evenly around a circumference of production tank 204. In some examples, electromagnets 206 may each be positioned in a same plane parallel with the x-z plane. Said another way, electromagnets may be positioned externally around the production tank. Additionally or alternatively, a bottom surface (with respect to gravity) of electromagnets 206 may be resting directly on a flat surface (e.g., a floor, platform, etc.) and a bottom surface of production tank 204 may be resting on the same flat surface. Both electromagnets 206 and production tank 204 may be heavy and may be more stable resting on a flat surface than suspended at any height above a surface. In some examples electromagnets 206 may each be positioned within a hermetically sealed housing which may be configured to actively cool electromagnets 206. In this way, resistive heating of electromagnets 206 may be mitigated and explosive reactions between a hot surface of electromagnets 206 and gasses evolved by the mixing process may be prevented.

Production tank 204 may be a cylindrical tank with a top opening 212 configured to receive hydrochloric acid and metallic iron pieces used in the production of ferrous chloride. Production tank 204 may be formed of a non-magnetic material which is compatible with long term exposure to highly concentrated hydrochloric acid. For example, production tank 204 may be formed of an acid resistant plastic such as polytetrafluoroethylene (PTFE), polyvinylidenefluoride (PVDF), and/or polypropylene (PP), among others. A thickness of walls of production tank 204 may be chosen such that a magnetic field generated by electromagnets 206 passes through the walls of production tank 204 to interact with metallic iron pieces. In one embodiment, production tank 204 may be a large production tank configured to hold up to 200 liters of material. Further, a diameter 214 of production tank 204 may be 0.5 meters.

External electromagnetic mixing system 202 may additionally include a power source 208 and a controller 210. Power source 208 may be separately electrically coupled to each of electromagnets 206. In this way each of electromagnets 206 may be energized or de-energized independently of each other. Power source 208 may supply current to windings of electromagnets 206, thereby energizing each of electromagnets 206, resulting in generation of a magnetic field which may attract pieces of metallic iron positioned within production tank 204. The magnetic field generated by electromagnets 206 when energized may be between 0.5 T and 2 T. The magnetic field strength may be chosen depending on a size of production tank 204. Power source 208 may be communicatively coupled to a controller 210. Controller 210 may include non-volatile memory storing instructions to sequentially energize each of electromagnets 206. For example, controller 210 may include instructions to energize first electromagnet 206a for a threshold amount of time. After the threshold amount of time elapses controller 210 may at substantially the same time de-energize first electromagnet 206a and energize second electromagnet 206b for the same threshold amount of time. After the threshold amount of time elapses again, controller 210 may simultaneously de-energize second electromagnet 206b and energize third electromagnet 206c for the threshold amount of time. Controller 210 may repeat the sequence until the metallic iron is fully reacted (e.g., fully dissolved). In this way a magnetized area within production tank 204 may move around an inner circumference of production tank 204 in a counter-clockwise fashion, thereby moving the ferromagnetic or ferromagnetic material around through interaction with the magnetic field and encouraging mixing. In an alternate embodiment, controller 210 may energize and de-energize electromagnets 206 separately but non-sequentially and/or for irregular time intervals, thereby moving the metallic iron through the hydrochloric acid in a non-circular motion. Both production tank 204 and electromagnets 206 are stationary while mixing occurs in this fashion. Further, controller 210 may be communicatively coupled to a user input 220 (e.g., keyboard, touch screen, etc.) configured to allow a user to adjust operation of electromagnets 206. In some examples, power source 208 and controller 210 may be spaced away and separated from production tank 204 to move possible ignition sources away from hydrogen gas which may evolve from the reaction performed in production tank 204.

In some embodiments external electromagnetic mixing system 202 may further include an internal sensor 216 and an external sensor 218. Internal sensor 216 may be communicatively coupled to controller 210, positioned within production tank 204 and in fluid communication with the liquid within production tank 204. Internal sensor 216 may be a sensor configured to sense a solution property which may change as mixing of the ferromagnetic or ferromagnetic solid occurs. For example, internal sensor 216 may be a temperature sensor or a conductivity sensor. In this way, progress of mixing may be monitored by controller 210. Additionally, external electromagnetic mixing system 202 may include external sensor 218. External sensor 218 may be coupled to one or more of electromagnets 206 and communicatively coupled to controller 210. External sensor 218 may be configured to sense changes in forces associated with interaction of the ferromagnetic and/or ferromagnetic solid with the magnetic field generated by electromagnets 206. For example, external sensor 218 may be configured as a back electromagnetic force sensor or an eddy current sensor. In this way, controller 210 may determine if mixing is occurring and may in some embodiments determine position of the ferromagnetic and/or ferromagnetic solids with respect to each of electromagnets 206 and automatically determine the threshold amount of time.

Turning now to FIG. 2B, a top view of external electromagnetic mixing system 202 is shown. Controller 210 and power source 208 are omitted for clarity. Production tank 204 may be configured to contain concentrated hydrochloric acid 253 and metallic iron pieces 252. However, other liquids and metallic ferromagnetic and/or ferrimagnetic solids have been considered within a scope of this disclosure. In some examples, the liquid may be a corrosive liquid. By mixing metallic iron in hydrochloric acid, the metallic iron may be oxidized to Fe²⁺ forming a solution comprising Fe²⁺ and Cl⁻ which may be used as an electrolyte in an IFB system, such as redox flow battery system 10 of FIG. 1. When electromagnets 206 are energized sequentially as described above with respect to FIG. 2A, an area of magnetization may move counter-clockwise around an interior of production tank 204 as indicated by arrow 256. Metallic iron pieces 252 may be attracted to the area of magnetization and thereby may also move around the interior of production tank 204 in the direction of arrow 256, following the area of magnetization. In this way, metallic iron pieces 252 may be mixed into hydrochloric acid 253. Additionally, interaction of the area of magnetization with metallic iron pieces 252 may cause formation of an eddy current around the metallic iron pieces 252 and/or ferromagnetic hysteresis within the metallic iron pieces 252 which may increase a temperature of metallic iron pieces 252, thereby increasing a rate at which metallic iron pieces 252 react with hydrochloric acid 253.

Turning now to FIGS. 3A and 3B, illustrations of an alternate embodiment of external electromagnetic mixing system 302 are shown. External electromagnetic mixing system 302 may include controller 210 and power source 208 as discussed above with respect to FIGS. 2A-2B. Such components are numbered similarly and will not be reintroduced. FIG. 3A shows a perspective view 300 of external electromagnetic mixing system 302 while FIG. 3B shows a cross-sectional view of external electromagnetic mixing system 302.

External electromagnetic mixing system 302 may include first electromagnet 306a, second electromagnet 306b, and third electromagnet 306c (collectively referred to as electromagnets 306). In one embodiment, electromagnets 306 may be smaller than electromagnets 206 and electromagnets 306 may be configured to emit a weaker magnetic field than electromagnets 206. Additionally, external electromagnetic mixing system 302 may include a stand 303 comprised of arms 310 and a base 308. A first end of each arm 310 may be in face sharing contact with each of electromagnets 306. A second end of each arm 310, opposite the first end of each arm 310 along the y-axis may be in face sharing contact with and physically coupled to base 308. In one embodiment, arms 310 and base 308 may be formed as a single piece. A number of electromagnets 306 may be equal to a number of arms 310. In one example, external electromagnetic mixing system 302 may include 3 arms 310 and 3 electromagnets 306. In alternate examples, a number of arms 310 and electromagnets 306 may be at least 2. Arms 310 and electromagnets 306 may be evenly spaced around an outer circumference of base 308. In one embodiment, arms 310 may extend a height 314 above a top surface 308a of base 308.

Base 308 may be formed as prismatic shape including top surface 308a parallel to a bottom surface. Top surface 308a and the bottom surface may be facing opposite each other across the y-axis. In this way, the bottom surface may lie flat on a flat surface such as a floor or table. In one embodiment, the prismatic shape of base 308 may correspond to a number of arms 310. For example, base 308 may be shaped as a letter Y when external electromagnetic mixing system 302 includes three arms 310. However, other shapes of base 308 have been considered (e.g., a circle or polygon) within a scope of this disclosure.

External electromagnetic mixing system 302 may include an opening 312 formed between electromagnets 306. Opening 312 may be configured to receive a production tank 356 described further below with respect to FIG. 3B. In one embodiment, production tank 356 may be smaller (e.g., hold a smaller volume of liquid) than production tank 204. For example, production tank 356 may be a 5-gallon bucket. A user may be able to easily lift the smaller production tank to fit through opening 312 and rest on base 308 to start mixing the contents of the smaller production tank and remove the smaller production tank again when mixing is finished. In this way, external electromagnetic mixing system 302 may be configured for the small production tank while external electromagnetic mixing system 202, may be configured for a large production tank (e.g., 200-liter production tank) which may not be easily lifted by the user.

Turning now to FIG. 3B, a cross-sectional view 350 along the x-axis of one arm 310 and second electromagnet 306b of external electromagnetic mixing system 302 is shown. A screw 352 may be used to secure second electromagnet 306b to the first end of arm 310. Similar screws may be used to secure each electromagnet 306 to the first end of each arm 310. Cross-sectional view 350 may further include a cross section of production tank 356 placed on external electromagnetic mixing system 302. An outer surface 356b of production tank 356 may be in face sharing contact with base 308 and with electromagnets 306, including second electromagnet 306b. When energized, second electromagnet 306b may generate a magnetic field attracting metallic iron pieces 252 held within production tank 356. In one example, metallic iron piece 252 may be held against inner surface 356a of production tank 356 by an energized second electromagnet 306b.

Turning now to FIG. 4, a flowchart of a method 400 for mixing a ferromagnetic and/or ferrimagnetic solid within a liquid using an external electromagnetic mixing system is shown. In one example, the ferromagnetic solid may be metallic iron and the liquid may be hydrochloric acid wherein a result of mixing is a solution including ferrous chloride. The external electromagnetic mixing system may be similar to external electromagnetic mixing system 202 and 302 as described above with respect to FIG. 2A-3B. Steps of method 400 may be at least partially executed by a controller such as controller 210 with executable instructions stored on non-transitory memory and in conjunction with sensors and user inputs communicatively coupled to the controller.

At 402, method 400 includes adding liquid and ferromagnetic and/or ferrimagnetic solid to a production tank. In some examples, the liquid may be a corrosive liquid. In an exemplary embodiment the liquid may be hydrochloric acid and the ferromagnetic solid may be metallic iron pieces. The production tank may be a large production tank (e.g., 200 L) such as production tank 204 of FIG. 2A-2B or a small production tank (e.g., 5 gallons) as shown in FIG. 3B. The production tank may be chosen based on an amount of hydrochloric acid and metallic iron used.

At 404, method 400 includes arranging electromagnets around the production tank. The electromagnets may be arranged to be in face sharing contact with an external wall of the production tank. In one embodiment, the electromagnets may be spaced evenly around a circumference of the production tank. In some embodiments, such as external electromagnetic mixing system 302, the electromagnets may be coupled to arms and a base, and arranging the electromagnets around the production tank may include placing the production tank through an opening of the electromagnetic mixing system and resting a bottom surface of the production tank on a top surface of the base. The electromagnets and production tank may remain stationary while the electromagnets are energized and de-energized as described below.

At 406, method 400 includes energizing an electromagnet. The electromagnet may be any one of the electromagnets arranged around the production tank. Energizing the electromagnet may generate a magnetic field inside the production tank, drawing the metallic iron pieces to the wall of the production tank at a position of the energized electromagnet. At 408, method 400 includes initiating a timer. In one example, the timer tracks an amount of elapsed time during which the electromagnet is energized.

At 410, method 400 includes determining if the timer is greater than a threshold time. The threshold time may be input by a user to the controller by a user interface. The duration of the threshold time may determine a mixing speed of the external electromagnetic mixing system. A shorter threshold time may briefly attract the metallic iron to the electromagnet and correspond to a faster mixing speed. A long threshold time may correspond to a slower mixing speed. In one example, the threshold time may be in a range of 0.25 seconds to 0.5 seconds. In some examples, the threshold time may be automatically adjusted by the controller in response to a signal from a sensor, such as external sensor 218 as described above with respect to FIG. 2A. If method 400 determines the timer is not greater than the threshold time, method 400 proceeds to 412 and includes continuing to energize the electromagnetic. Method 400 proceeds from 412 to 410 and may continue to energize the electromagnet until the timer passes the threshold time.

If method 400 determines the timer is greater than the threshold time, method 400 proceeds to 414 and includes determining if additional mixing is demanded. Additional mixing may be demanded if the metallic iron is not fully reacted (e.g., not fully dissolved) with the hydrochloric acid. In one example, full reaction of the metallic iron may be determined by feedback from a sensor of the electromagnetic mixing system. Additionally or alternatively, full reaction of the metallic iron may be determined by a user. The user may input a command to the controller depending on whether the metallic iron is observed to be fully reacted.

If method 400 determines that additional mixing is demanded, method 400 proceeds to 418. At 418, method 400 includes de-energizing the energized magnet and energizing a different electromagnetic. In one example, the different electromagnet may be a neighboring electromagnet. The neighboring electromagnet may be a closest electromagnet to the energized electromagnetic in a clockwise or counter clockwise direction. Method 400 then returns to 408 and initiates the timer. In this way, electromagnets of the external electromagnetic mixing system may be sequentially activated, thereby drawing metallic iron pieces around and/or across the production tank thereby mixing the metallic iron pieces in the hydrochloric acid and speeding a reaction of the metallic iron with the hydrochloric acid. Additionally, movement of the metallic iron pieces through the magnetic fields generated by the electromagnets may result in heating the metallic iron pieces and further increase a rate of reaction.

If method 400 determines that additional mixing is not demanded, method 400 proceeds to 416 and includes de-energizing all electromagnets. At 420, following step 416, method 400 includes transferring contents of the production tank to a redox flow battery system. In some examples, the contents may be a solution formed by mixing caused by the electromagnetic mixing system and the solution may be transferred to an electrolyte subsystem of a redox flow battery system (e.g., electrolyte subsystem 130 of FIG. 1). As one example, when the liquid is hydrochloric acid and the ferromagnetic pieces are metallic iron, the resulting solution may include ferrous chloride which may comprise an electrolyte of a redox flow battery system.

The technical effect of method 400 is to allow mixing of metallic iron pieces into hydrochloric acid to prepare ferrous chloride by an external electromagnetic mixing system without directly exposing a user or machinery to the corrosive hydrochloric acid or the hazardous gasses evolved by the reaction occurring in the mixture. In this way, a cost of the preparation of ferrous chloride may be reduced by reducing a frequency at which mixing equipment demands repair or replacement. Additionally, the external electromagnetic mixing system may heat the metallic iron pieces from within the mixture without demanding additional heaters.

The disclosure also provides support for an external electromagnetic mixing system, comprising: a plurality of electromagnets spaced externally around a production tank, wherein the production tank contains a liquid and a ferromagnetic and/or ferrimagnetic solid, and wherein the plurality of electromagnets are configured to move the ferromagnetic and/or ferrimagnetic solid within the liquid. In a first example of the system, the plurality of electromagnets are communicatively coupled to a controller. In a second example of the system, optionally including the first example, the plurality of electromagnets are positioned within hermetically scaled housing. In a third example of the system, optionally including one or both of the first and second examples, the system further comprises: an internal sensor and/or an external sensor. In a fourth example of the system, optionally including one or more or each of the first through third examples, the liquid is hydrochloric acid and the ferromagnetic and/or ferrimagnetic solid is metallic iron. In a fifth example of the system, optionally including one or more or each of the first through fourth examples, the plurality of electromagnets are each coupled to an arm of a stand. In a sixth example of the system, optionally including one or more or each of the first through fifth examples, the plurality of electromagnets are not physically coupled to the production tank.

The disclosure also provides support for a method of mixing a ferromagnetic and/or ferrimagnetic solid, comprising: adding a liquid and the ferromagnetic and/or ferrimagnetic solid to a production tank, positioning electromagnets of an external electromagnetic mixing apparatus externally around the production tank, energizing a first electromagnet for a threshold time, in response to the threshold time elapsing, de-energizing the first electromagnet and energizing a different electromagnet, and transferring a solution from the production tank to a redox flow battery system. In a first example of the method, a duration of the threshold time determines a mixing speed. In a second example of the method, optionally including the first example, a duration of the threshold time is adjusted in response to a signal from an external sensor and/or an internal sensor. In a third example of the method, optionally including one or both of the first and second examples, the method further comprises: determining if additional mixing is demanded before transferring the solution. In a fourth example of the method, optionally including one or more or each of the first through third examples, determining if additional mixing is demanded includes receiving feedback from an external sensor and/or an internal sensor. In a fifth example of the method, optionally including one or more or each of the first through fourth examples, the different electromagnet is a neighboring electromagnet to the first electromagnet. In a sixth example of the method, optionally including one or more or each of the first through fifth examples, the solution includes ferrous chloride.

The disclosure also provides support for a system, comprising: a plurality of electromagnets spaced externally around a production tank, a redox flow battery system configured to receive a contents of the production tank, a power source electrically coupled to the plurality of electromagnets, a controller coupled to the power source, including executable instructions stored on non-transitory memory that, when executed, cause the controller to: energize a first electromagnet for a threshold time, and in response to the threshold time elapsing, de-energize the first electromagnet and energize a neighboring electromagnet. In a first example of the system, the redox flow battery system is an iron redox flow battery system and the contents of the production tank includes a ferrous chloride solution. In a second example of the system, optionally including the first example, the plurality of electromagnets are configured to generate a magnetic field between 0.5 T and 2 T. In a third example of the system, optionally including one or both of the first and second examples, the system is configured to mix the contents of the production tank while the production tank and the plurality of electromagnets remain stationary. In a fourth example of the system, optionally including one or more or each of the first through third examples, the system further comprises: an external sensor and/or an internal sensor. In a fifth example of the system, optionally including one or more or each of the first through fourth examples, the external sensor is an eddy current sensor or a back electromagnetic force sensor and the internal sensor is a temperature sensor or a conductivity sensor.

FIGS. 2A-3B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2A-3B are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An external electromagnetic mixing system, comprising:
a plurality of electromagnets spaced externally around a production tank, wherein the production tank contains a liquid and a ferromagnetic and/or ferrimagnetic solid, and wherein the plurality of electromagnets are configured to move the ferromagnetic and/or ferrimagnetic solid within the liquid.

2. The external electromagnetic mixing system of claim 1, wherein the plurality of electromagnets are communicatively coupled to a controller.

3. The external electromagnetic mixing system of claim 1, wherein the plurality of electromagnets are positioned within a hermetically sealed housing.

4. The external electromagnetic mixing system of claim 1, further comprising an internal sensor and/or an external sensor.

5. The external electromagnetic mixing system of claim 1, wherein the liquid is hydrochloric acid and the ferromagnetic and/or ferrimagnetic solid is metallic iron.

6. The external electromagnetic mixing system of claim 1, wherein the plurality of electromagnets are each coupled to an arm of a stand.

7. The external electromagnetic mixing system of claim 1, wherein the plurality of electromagnets are not physically coupled to the production tank.

8. A method of mixing a ferromagnetic and/or ferrimagnetic solid, comprising:
adding a liquid and the ferromagnetic and/or ferrimagnetic solid to a production tank;
positioning electromagnets of an external electromagnetic mixing apparatus externally around the production tank;
energizing a first electromagnet for a threshold time;
in response to the threshold time elapsing, de-energizing the first electromagnet and energizing a different electromagnet; and
transferring a solution from the production tank to a redox flow battery system.

9. The method of claim 8, wherein a duration of the threshold time determines a mixing speed.

10. The method of claim 8, wherein a duration of the threshold time is adjusted in response to a signal from an external sensor and/or an internal sensor.

11. The method of claim 8, further comprising determining if additional mixing is demanded before transferring the solution.

12. The method of claim 11, wherein determining if additional mixing is demanded includes receiving feedback from an external sensor and/or an internal sensor.

13. The method of claim 8, wherein the different electromagnet is a neighboring electromagnet to the first electromagnet.

14. The method of claim 8, wherein the solution includes ferrous chloride.

15. A system, comprising:
a plurality of electromagnets spaced externally around a production tank;
a redox flow battery system configured to receive a contents of the production tank;
a power source electrically coupled to the plurality of electromagnets;
a controller coupled to the power source, including executable instructions stored on non-transitory memory that, when executed, cause the controller to:
energize a first electromagnet for a threshold time, and
in response to the threshold time elapsing, de-energize the first electromagnet and energize a neighboring electromagnet.

16. The system of claim 15, wherein the redox flow battery system is an iron redox flow battery system and the contents of the production tank includes a ferrous chloride solution.

17. The system of claim 15, wherein the plurality of electromagnets are configured to generate a magnetic field between 0.5 T and 2 T.

18. The system of claim 15, wherein the system is configured to mix the contents of the production tank while the production tank and the plurality of electromagnets remain stationary.

19. The system of claim 15, further comprising an external sensor and/or an internal sensor.

20. The system of claim 19, wherein the external sensor is an eddy current sensor or a back electromagnetic force sensor and the internal sensor is a temperature sensor or a conductivity sensor.
